(19) United States
(12) Patent Application Publication
(10) Pub. No.: US 2015/0127135 A1
(43) Pub. Date: May 7, 2015

(54) METHODS FOR MACHINING SHARP INTERNAL POCKET CORNERS WITH ROTATING CUTTING TOOLS

(71) Applicant: Apple Inc., Cupertino, CA (US)

(72) Inventors: Simon Regis Louis Lancaster-Larocque, Gloucester (CA); Hilbert T. Kwan, San Jose, CA (US)

(73) Assignee: Apple Inc., Cupertino, CA (US)

(21) Appl. No.: 14/221,195

(22) Filed: Mar. 20, 2014

Related U.S. Application Data
(60) Provisional application No. 61/900,858, filed on Nov. 6, 2013.

(51) Int. Cl. G05B 19/18

(52) U.S. Cl. CPC G05B 19/182
USPC 700/160

(57) ABSTRACT

Methods of machining a housing of a portable computing device are provided. A cutting tool may be moved perpendicularly to a rotational axis during each rotation thereof to machine a substrate and define pockets and holes including substantially non-rounded corners. In this regard, the cutting tool may be translated perpendicularly to the rotational axis during each rotation of the cutting tool to define a non-rounded cutting profile, where desired. Translation movement perpendicular to the rotational axis may be provided by a controller actively controlling actuators of a computer numerical control (CNC) mill or other rotary machine.

### CROSS-REFERENCE TO RELATED APPLICATIONS

This application claims the benefit of priority under 35 U.S.C §119(e) to U.S. Provisional Application No. 61/900,858, filed on Nov. 6, 2013, the disclosure of which is incorporated herein by reference in its entirety.

### FIELD

The present disclosure relates generally to cutting tools, and more particularly to a method for machining a corner in a substrate using a cutting tool and a rotary machine.

### BACKGROUND

Components employed to form various devices such as computing devices often undergo numerous manufacturing operations during the production thereof. Additive manufacturing processes add material to form a component. By way of example, injection molding may be employed to form a component. Conversely, subtractive manufacturing processes remove material from a workpiece or substrate to form a component. For example, material may be machined from a substrate to form the component. In some embodiments additive and subtractive processes may both be employed to form a component, depending on the particular desired final configuration of the component.

Computer numerical control (CNC) machining is one example of a type of subtractive manufacturing process commonly employed to form components. CNC machining typically employs a robotic assembly and a controller. The robotic assembly typically may include a rotating spindle to which a milling cutter is coupled. The milling cutter includes cutting edges that remove material from a substrate to form a component defining a desired shape and dimensions. In this regard, the controller directs the robotic assembly to move the milling cutter along a machining path that forms the component.

However, CNC machining may not be configured to form certain desired shapes of components. Accordingly, improved methods for machining may be desirable.

### SUMMARY

Embodiments of the present disclosure relate to machining methods. More particularly, the present disclosure provides methods for moving a cutting tool perpendicularly to a rotational axis during each rotation thereof to machine a substrate and define pockets and holes including substantially non-rounded corners. In this regard, the cutting tool may be translated perpendicularly to the rotational axis during each rotation of the cutting tool to define a non-rounded cutting profile, where desired. Translation perpendicular to the rotational axis may be provided by a controller actively controlling actuators of a computer numerical control (CNC) mill or other rotary machine.

In another aspect, a method of boring a rectangular hole into a substrate of a computing device with a material removal system having a spindle pivotally coupled to a substantially triangular cutting tool is described. The method includes plunging the substantially triangular cutting tool along an axis of rotation of the substantially triangular cutting tool into contact with the substrate, simultaneously rotating the cutting tool and translating the cutting tool in the substrate, and forming the rectangular hole in the substrate.

In another aspect, a non-transitory computer readable medium for storing computer code executable by a processor in a computer system having at least one rotational component is described. The a non-transitory computer readable medium includes a computer code for running an electronic device comprising a communication interface, a user interface, a processor, and a manufacturing module, computer code for allowing a user to interact with the electronic device via the user interface, computer code for transmitting and receiving data via the communications interface; and computer code for controlling the manufacturing module to provide rotational and translational movement of a cutting tool.

Other apparatuses, methods, features and advantages of the disclosure will be or will become apparent to one with skill in the art upon examination of the following figures and detailed description. It is intended that all such additional systems, methods, features and advantages be included within this description, be within the scope of the disclosure, and be protected by the accompanying claims.

### BRIEF DESCRIPTION OF THE DRAWINGS

The included drawings are for illustrative purposes and serve only to provide examples of possible structures and arrangements for the disclosed apparatuses, assemblies, methods, and systems. These drawings in no way limit any changes in form and detail that may be made to the disclosure by one skilled in the art without departing from the spirit and scope of the disclosure.

FIG. 1 illustrates a front facing perspective view of an embodiment of the portable computing device in a closed configuration according to an example embodiment of the present disclosure;

FIG. 2 illustrates the portable computing device of FIG. 1 in an open configuration according to an example embodiment of the present disclosure;

FIG. 3 illustrates a bottom perspective view of a top case of a base portion of the portable computing device of FIG. 1 according to an example embodiment of the present disclosure;

FIG. 4 illustrates a bottom view of the portable computing device of FIG. 1 according to an example embodiment of the present disclosure;

FIG. 5 schematically illustrates a computer numerical control (CNC) mill including a cutting tool according to an embodiment of the present disclosure;

FIG. 6 illustrates the cutting tool cutting a substrate according to an example embodiment of the present disclosure;

FIG. 7 schematically illustrates a material removal system according to an example embodiment of the present disclosure;

FIG. 8 illustrates a top view of a cutting tool defining a triangular configuration and including straight cutting edges according to an example embodiment of the present disclosure;

FIG. 9 illustrates a top view of a cutting tool defining a substantially triangular configuration and including curved cutting edges according to an example embodiment of the present disclosure;

FIG. 10 illustrates rotational and translational movement of a cutting tool during plunging machining of a square hole according to an embodiment of the present disclosure;

FIG. 11 illustrates a side view of the cutting tool and the substrate while cutting a pocket in the substrate according to an example embodiment of the present disclosure;

FIG. 12 illustrates a modified top view of the cutting tool and the substrate of FIG. 11 while cutting a pocket in the substrate according to an example embodiment of the present disclosure;

FIG. 13 illustrates a modified top view of a cutting tool of the material removal system of FIG. 7 while cutting a pocket in a substrate according to an example embodiment of the present disclosure;

FIG. 14 schematically illustrates a machining method according to an example embodiment of the present disclosure; and

FIG. 15 schematically illustrates a block diagram of an electronic device according to an example embodiment of the present disclosure.

### DETAILED DESCRIPTION

Representative applications of systems, apparatuses, computer program products and methods according to the presently described embodiments are provided in this section. These examples are being provided solely to add context and aid in the understanding of the described embodiments. It will thus be apparent to one skilled in the art that the presently described embodiments can be practiced without some or all of these specific details. In other instances, well known process steps have not been described in detail in order to avoid unnecessarily obscuring the presently described embodiments. Other applications are possible, such that the following examples should not be taken as limiting.

As described in detail below, the following relates to manufacturing tools, assemblies, apparatuses, systems, devices, computer program products, and methods. Embodiments of the disclosure may be employed to form a variety of components including, for example, electronic devices. By way of more specific example, the manufacturing methods disclosed herein may be employed in manufacturing a computing device such as a desktop computer, a laptop computer, a net book computer, a tablet computer, a cellphone, a smartphone, etc., or any accessory therefor such as a keyboard and a monitor. Thus, purely for purposes of example, embodiments of a portable computing device that may be formed by these manufacturing methods are described and illustrated herein. However it should be understood that various other embodiments of devices may be formed using the tools, assemblies, apparatuses, systems, devices, computer program products, and methods of the present disclosure.

In one embodiment a portable computing device can include a multi-part housing having a top case and a bottom case joining at a reveal to form a base portion. The portable computing device can have an upper portion (or lid) that can house a display screen and other related components whereas the base portion can house various processors, drives, ports, battery, keyboard, touchpad and the like. The top case and the bottom case can each be joined in a particular manner at an interface region such that the gap and offset between top and bottom cases are not only reduced, but are also more consistent from device to device during the mass production of devices.

In a particular embodiment, the lid and base portion can be pivotally connected with each other by way of what can be referred to as a clutch assembly. The clutch assembly can include at least a cylindrical portion that in turn includes an annular outer region, and a central bore region surrounded by the annular outer region, the central bore suitably arranged to provide support for electrical conductors between the base portion and electrical components in the lid. The clutch assembly can also include a plurality of fastening regions that couple the clutch to the base portion and the lid of the portable computing device with at least one of the fastening regions being integrally formed with the cylindrical portion such that space, size and part count are minimized.

The top case can include a cavity, or lumen, into which a plurality of operational components can be inserted during an assembly operation. In the described embodiment, the operational components can be inserted into the lumen and attached to the top case in a “top-bottom” assembly operation in which top most components are inserted first followed by components in a top down arrangement. For example, the top case can be provided and shaped to accommodate a keyboard module. The keyboard module can include a keyboard assembly formed of a plurality of keycap assemblies and associated circuitry, such as a flexible membrane on which can be incorporated a switching matrix and protective feature plate. Therefore, following the top-bottom assembly approach, the keyboard assembly is first inserted into the top case followed by the flexible membrane and then the feature plate that is attached to the top case. Other internal components can then be inserted in a top to bottom manner (when viewed from the perspective of the finished product).

In one embodiment, the keyboard module can be configured in such a way that a keycap assembly can be used to replace a power switch. For example, in a conventional keyboard each of a top row of keycaps can be assigned at least one function. However, by re-deploying one of the keycaps as a power button, the number of operational components can be reduced by at least eliminating the switch mechanism associated with the conventional power button and replacing it with the already available keycap assembly and associated circuitry.

In addition to the keyboard, the portable computing device can include a touch sensitive device along the lines of a touch pad, touch screen, etc. In those embodiments where the portable computing device includes a touch pad the touch pad can be formed from a glass material. The glass material provides a cosmetic surface and is the primary source of structural rigidity for the touchpad. The use of the glass material in this way significantly reduces the overall thickness of the touchpad compared to previous designs. The touchpad can include circuitry for processing signals from a sensor associated with the touchpad. In one embodiment, the circuitry can be embodied as a printed circuit board (PCB). The PCB can be formed of material and placed in such a way that it provides structural support for the touchpad. Thus, a separate touchpad support is eliminated.

In one embodiment, the top case can be formed from a single billet of aluminum that is machined into a desired shape and size. The top case can include an integrated support system that adds to the structural integrity of the top case. The integrated support system can be continuous in nature in that there are no gaps or breaks. The integrated support system can be used to provide support for individual components (such as a keyboard). For example, the integrated support system can take the form of ribs that can be used as a reference datum for a keyboard. The ribs can also provide additional structural support due to the added thickness of the ribs. The ribs can also be used as part of a shield that helps to prevent light leaking from the keyboard as well as act as a Faraday cage that prevents leakage of extraneous electromagnetic radiation.

The continuous nature of the integrated support system can result in a more even distribution of an external load applied to the multi-part housing resulting in a reduced likelihood of warping, or bowing that reduces risk to internal components. The integrated support system can also provide mounting structures for those internal components mounted to the multi-part housing. Such internal components include a mass storage device (that can take the form of a hard disk drive, HDD, or solid state drive, SSD), audio components (audio jack, microphone, speakers, etc.) as well as input/output devices such as a keyboard and touch pad.

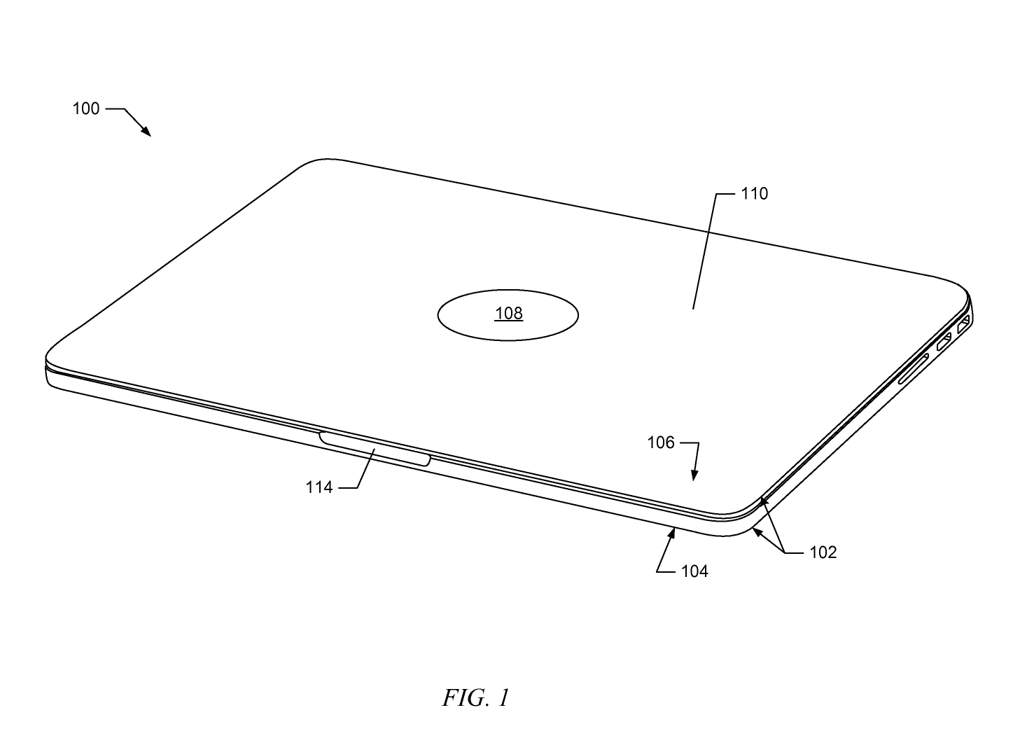

These and other embodiments are discussed below with reference to FIGS. 1-4. However, those skilled in the art will readily appreciate that the detailed description given herein with respect to these figures is for explanatory purposes only.

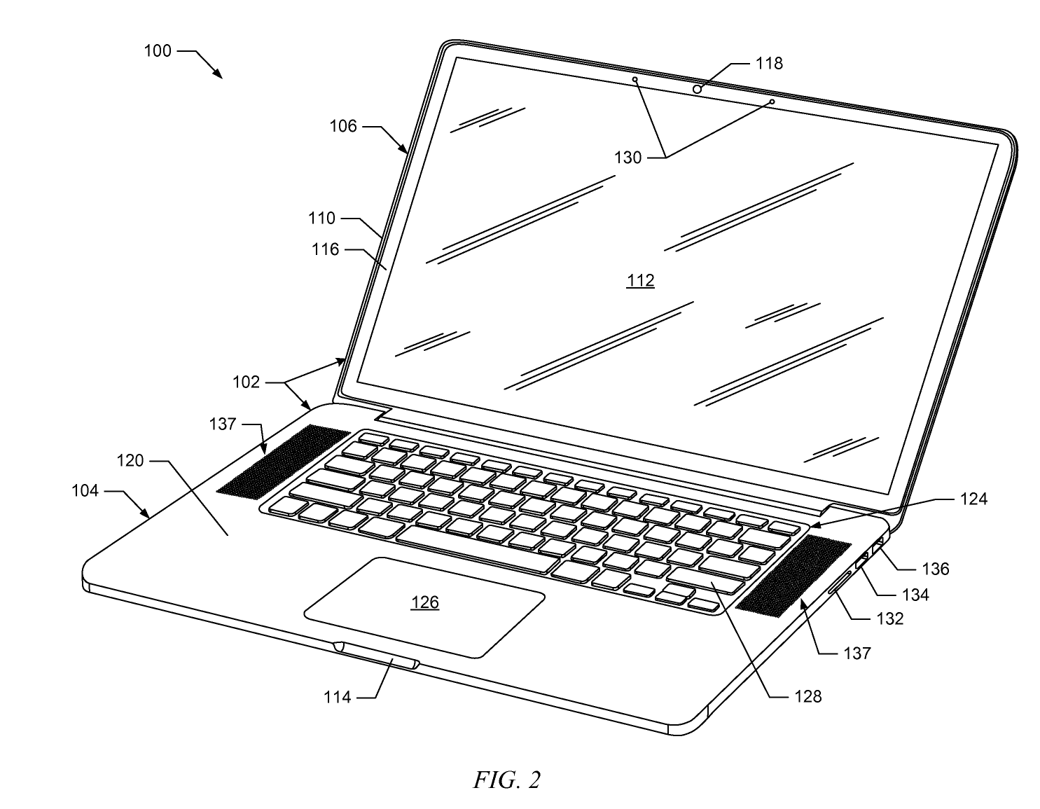

FIG. 1 illustrates a portable computing device 100 in the form of a laptop computer in accordance with an example embodiment of the present disclosure. More particularly, FIG. 1 shows a front facing perspective view of the portable computing device 100 in a closed configuration. As illustrated, the portable computing device 100 may include a housing 102 comprising a base portion 104 and a lid portion 106. In the closed configuration, the lid portion 106 and the base portion 104 form what appears to be a uniform structure having a continuously varying and coherent shape that enhances both the look and feel of the portable computing device 100. In some embodiments portable computing device 100 may include a logo 108 at a rear case 110 of the lid portion 106 of the housing 102. In one embodiment, the logo 108 can be illuminated by light emitted from a display 112 (see, e.g., FIG. 2).

The base portion 104 can be pivotally connected to the lid portion 106 by way of a hinge that may include a clutch assembly in some embodiments. The base portion 104 may include an inset portion 114 suitable for assisting a user in lifting the lid portion 106 by, for example, a finger. Accordingly, the lid portion 106 of the housing 102 can be moved with respect to the base portion 104 of the housing with the aid of the clutch assembly from a closed position (see, e.g., FIG. 1) to an open position (see, e.g., FIG. 2).

FIG. 2 shows a front facing perspective view of the portable computing device 100 in the open configuration. The display 112 may be coupled to the rear case 110 of the lid portion 106 such that the display is provided with structural support. In this regard, the lid portion 106 can be formed to have uni-body construction provided by the rear case 110 that can provide additional strength and resiliency to the lid portion 106 which is particularly important due to the stresses caused by repeated opening and closing. In addition to the increase in strength and resiliency, the uni-body construction of the lid portion 106 can reduce overall part count by eliminating separate support features, which may decrease manufacturing cost and/or complexity.

The lid portion 106 may include a mask (also referred to as display trim) 116 that surrounds the display 112. The display trim 116 can be formed of an opaque material such as ink deposited on top of or within a protective layer of the display 112. Thus, the display trim 116 can enhance the overall appearance of display 112 by hiding operational and structural components as well as focusing attention onto the active area of the display 112.

The display 112 can display visual content such as a graphical user interface, still images such as photos, and video media items such as movies. The display 112 can display images using any appropriate technology such as a liquid crystal display (LCD), a light emitting diode (LED) display, or an organic light emitting diode (OLED) display, etc. Further, the portable computing device 100 may include an image capture device 118. In one embodiment the image capturing device 118 may be located on a transparent portion of the display trim 116. The image capture device 118 can be configured to capture both still and video images in some embodiments.

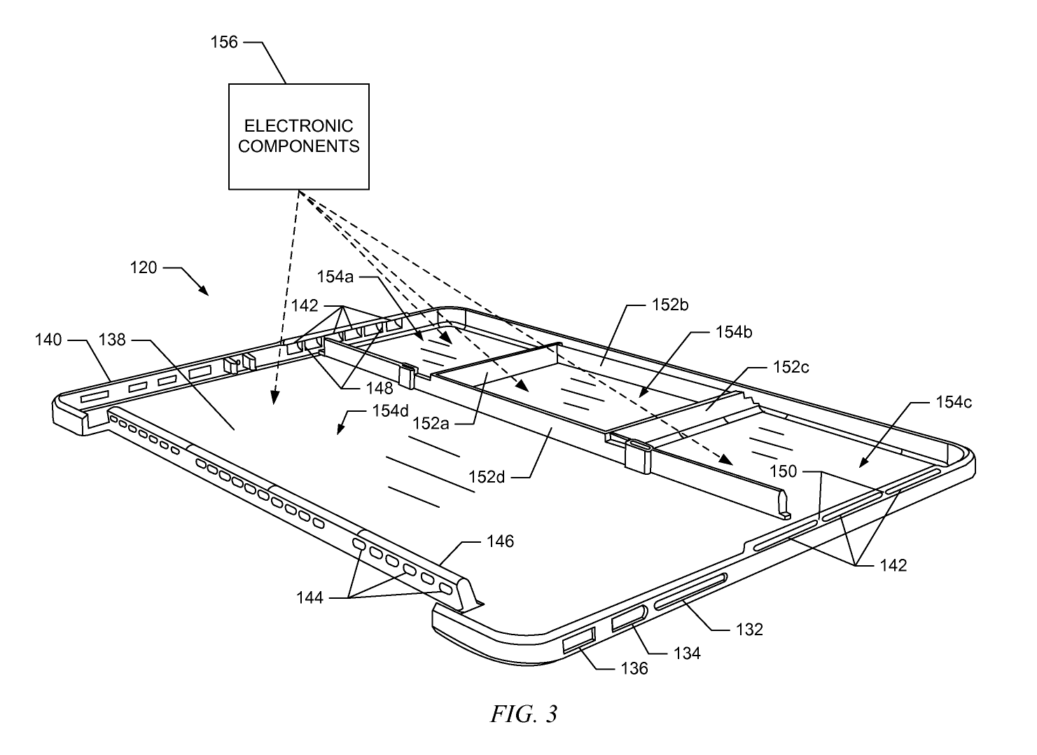

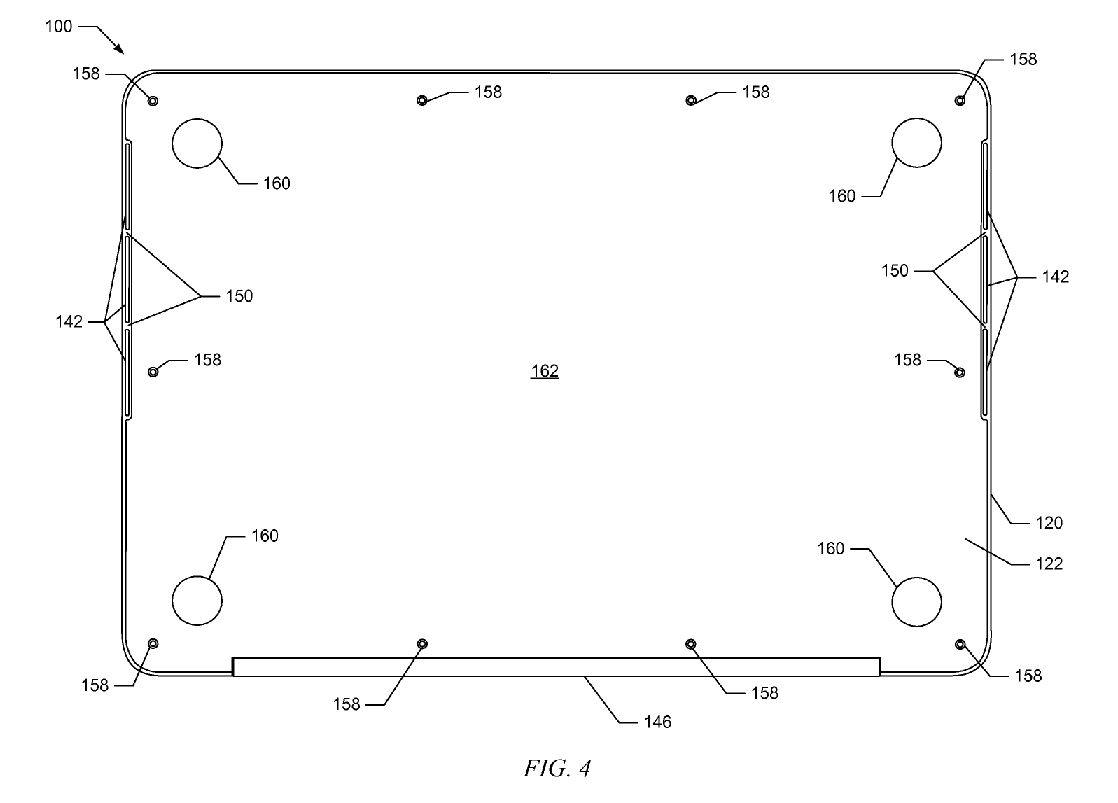

The base portion 104 may comprise a top case 120 (see, e.g., FIG. 3) fastened to a bottom case 122 (see, e.g., FIG. 4). As illustrated in FIG. 2, the top case 120 can be configured to accommodate various user input devices such as a keyboard 124 and a touchpad 126. The keyboard 124 can include a plurality of low profile keycap assemblies 128. In one embodiment, an audio transducer (not shown) can use selected portions of keyboard 124 to control output audio signals such as music. One or more microphones 130 can be located on the lid portion 106. The microphones 130 may be spaced apart to improve frequency response of an associated audio circuit.

Each of the plurality of keycap assemblies 128 can have a symbol imprinted thereon for identifying the key input associated with the particular key pad. The keyboard 124 can be arranged to receive a discrete input at each keycap assembly 128 using a finger motion referred to as a keystroke. In the described embodiment, the symbols on each keycap assembly 128 can be laser etched thereby creating an extremely clean and durable imprint that will not fade under the constant application of keystrokes over the life of portable computing device 100. In order to reduce component count, one of the keycap assemblies 128 can be re-provisioned as a power button. In this way, the overall number of components in the portable computing device 100 can be commensurably reduced.

The touchpad 126 can be configured to receive finger gesturing. A finger gesture can include touch events from more than one finger applied in unison. The gesture can also include a single finger touch event such as a swipe or a tap. The gesture can be sensed by a sensing circuit in the touchpad 126 and converted to electrical signals that are passed to a processing unit for evaluation. In this way, portable computing device 100 can be at least partially controlled by touch.

One or more data ports 132, 134, 136 can be used to transfer data and/or power between an external circuit(s) and the portable computing device 100. Data port 132 can be an input slot that can be used to accept a memory card (such as a FLASH memory card), whereas the remaining data ports 134, 136 can be used to accommodate data connections such as USB, FireWire, Thunderbolt, and so on. Further, in some embodiments, one or more speaker grids 137 can be used to output audio from an associated audio component enclosed within base portion 104 of the housing 102.

FIG. 3 illustrates a perspective bottom view of the top case 120 of the base portion 104 of the housing 102. As illustrated, the top case 120 may comprise a major wall 138 and an outer rim 140 extending therefrom. A plurality of vents 142 may be defined in the top case 120. For example, the vents 142 are defined in the outer rim 140 in the illustrated embodiment. The vents 142 may be configured to provide a flow of outside air that can be used to cool internal components by allowing air to enter or exit therethrough. For example, the vents 142 in the outer rim 140 may comprise intake vents and a plurality of vents 144 defined in a rear wall 146 may comprise exhaust vents. In another embodiment the vents 142 in the outer rim 140 can act as a secondary air intake subordinate to primary air intake vents or the vents in the outer rim may comprise exhaust vents.

The vents 142 in the outer rim 140 can also be used to output audio signals in the form of sound generated by an audio module. Accordingly, the vents 142 can be used to output sound at a selected frequency range in order to improve quality of an audio presentation by the portable computing device 100. Additionally, the vents 142 in the outer rim 140 can be part of an integrated support system for the top case 120. In this regard, internal ribs 148 may be positioned within the vents 142 and/or external ribs 150 may be positioned between the vents to provide additional structural support to the portable computing device 100. In some embodiments the vents 142 may be machined from the material defining the top case 120 with the ribs 148, 150 comprising retained material.

The cadence and size of the vents 142 can be used to control air flow into portable computing device 100 as well as control emission of radio frequency (RF) energy in the form of electromagnetic interference (EMI) from the portable computing device. In this regard, the internal ribs 148 can separate an area within the vents 142 to produce an aperture sized to reduce passage of RF energy. The size of an aperture defined by each of the vents 142 may dictate the wavelength of RF energy that can be “trapped” by the aperture. In this case, the size of vents 142 is such that a substantial portion of RF energy emitted by internal components can be trapped within the portable computing device 100. Furthermore, by placing vents 142 at a downward facing outer surface of the top case 120, the aesthetics of portable computing device 100 can be enhanced since views of internal components from an external observer are eliminated during normal use.

As illustrated, the rear wall 146 may extend from the major wall 138. The rear wall 146 may be configured to hide the clutch at the hinge between the base portion 104 and the lid portion 106 of the housing 102. A plurality of inner sidewalls 152a-d may also extend from the major wall 138. The inner sidewalls 152a-d may divide an interior space defined by the base portion 104 into a plurality of compartments 154a-d.

As schematically illustrated in FIG. 3, the portable computing device 100 may include a plurality of electronic components 156, which may be received in one or more of the compartments 154a-d. As may be understood, by way of example, the electronic components 156 may include a mass storage device (e.g., a hard drive or a solid state storage device such as a flash memory device including non-transitory and tangible memory that may be, for example, volatile and/or non-volatile memory) configured to store information, data, files, applications, instructions or the like. The electronic components 156 may also include a processor (e.g., a microprocessor or controller) configured to control the overall operation of the portable electronic device. The electronic components 156 may further include a communication interface configured for transmitting and receiving data through, for example, a wired or wireless network such as a local area network (LAN), a metropolitan area network (MAN), and/or a wide area network (WAN), for example, the Internet. The electronic components 156 may further include a fan, a heat pipe, and one or more batteries. However, various other electronic components may additionally or alternatively be received in the housing 102 of the portable electronic device as may be understood by one having skill in the art.

FIG. 4 shows an external view of the bottom of the bottom case 122 of the base portion 104 of the housing 102. One or more fasteners 158 may be positioned at the bottom case 122 of the base portion 104 of the housing 102. The fasteners 158 may be configured to secure the bottom case 122 to the top case 120 to enclose the above-described electronic components 156.

Additionally, in some embodiments the portable computing device 100 may include one or more bumpers. Bumpers may serve a variety of purposes. In this regard, in the illustrated embodiment the portable computing device 100 includes bumpers in the form of feet 160 coupled to an outer surface 162 of the bottom case 122 of the base portion 104 of the housing 102.

Devices such as the above-described portable computing device 100 may be produced by machining a substrate to define one or more components thereof. For example, computer numerical control (CNC) machining may be employed to form components of the portable computing device 100. By way of more particular example, a CNC mill may be employed to form components of the portable computing device 100.

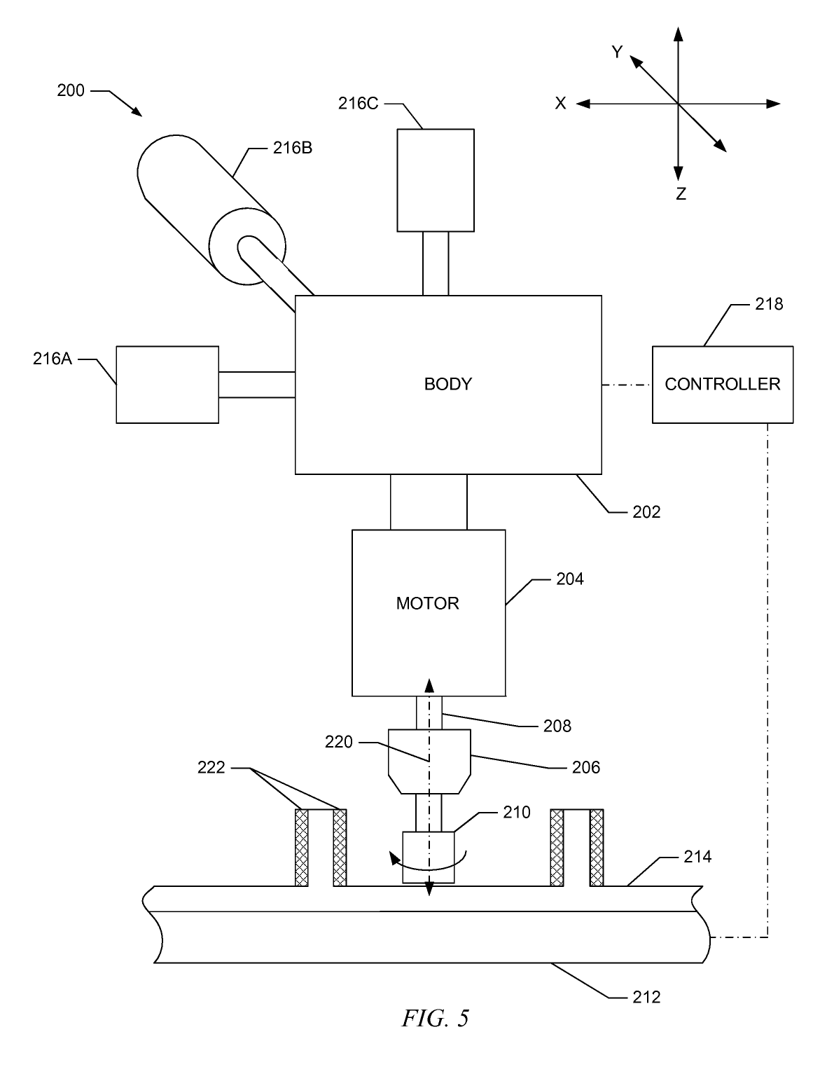

In this regard, FIG. 5 illustrates an example embodiment of a CNC mill 200 according to an example embodiment of the present disclosure. In one embodiment the CNC mill 200 may comprise a 3-axis vertical mill available from FANUC Corporation of Oshino-mura, Japan. However, various other embodiments of CNC mills may be employed in accordance with embodiments of the present disclosure.

As illustrated, the CNC mill 200 may include a machine body 202. The CNC may further comprise a motor 204 configured to rotate a rotary head 206 coupled thereto via a spindle 208. The rotary head 206 may couple to a cutting tool 210 such as any of various milling cutters. A machining table 212 may be configured to support a workpiece or substrate 214. The machining table 212 may be stationary or configured to move in one or more directions.

Additionally, the machine body 202 or an arm or other member extending therefrom may be configured to move. In this regard, the CNC mill 200 may further comprise actuators 216A-C. In the illustrated embodiment the actuators 216 A-C are configured to move the machine body 202 and, therefore, the spindle 208, rotary head 206, and cutting tool 210 due to coupling therewith. More particularly, a first actuator 216A is configured to move the machine body 202 along an X-axis, a second actuator 216B is configured to move the machine body along a Y-axis, and a third actuator 216C is configured to move the machine body along a Z-axis. Various embodiments of actuators may be employed such as hydraulic or pneumatic actuators.

Further, the CNC mill 200 may include a controller 218. The controller 218 may direct the motor 204 to rotate, which may in turn rotate the spindle 208, the rotary head 206, and the cutting tool 210 coupled thereto about an axis 220. Further, the controller 218 may direct movement of the cutting tool 210 relative to the substrate 214. For example, the machining table 212 may move the substrate 214 or the actuators 216A-C may move the machine body 202 and/or other portion of the CNC mill to move the cutting tool 210.

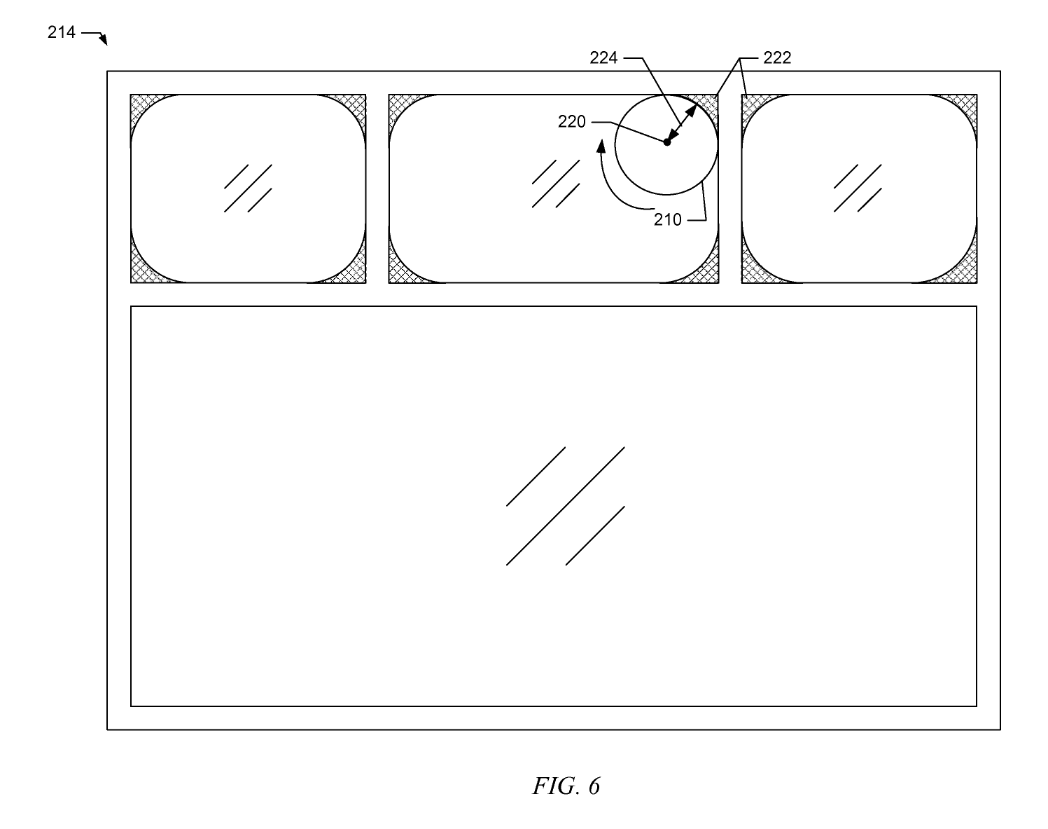

Accordingly, the CNC mill 200 may remove material from the substrate 214 to form a component. For example, the substrate 214 may be machined to form the above-described top case 120 of the base portion 104 of the housing 102. However, depending on the characteristics of the cutting tool 210 and the desired shape of the component, the cutting tool may be incapable of removing material from the substrate 214 to the desired extent. In this regard, as illustrated in FIGS. 5 and 6, after machining the substrate 214 with the cutting tool 210 of the CNC mill 200, certain remaining material sections 222 may exist. As illustrated in FIG. 6, the remaining material sections 222 may result from the cutting tool 210 defining a round cross-section perpendicular to the rotational axis 220 thereof. Accordingly, the cutting tool 210 may be incapable of forming square corners in the substrate 214. Rather, the remaining material sections 222 may define a radius of curvature 224 substantially equal to a radius of the cutting tool 210. Thus, the remaining material sections 222, defining a rounded configuration, may be present at the desired corners.

In the production of some embodiments of components, formation of rounded corners defining relatively large radii of curvature may not be of concern. However, in other embodiments of components, rounded corners defining relatively large radii of curvature may detrimentally affect the product produced therefrom. For example, in the portable computing device 100 described above, rounded corners between the inner sidewalls 152a-d may result in a reduction in volume of the compartments 154a-d (see, e.g., FIG. 3). Thereby, the size of the electronic components 156 received in the compartments 154a-d may have to be reduced. Thus, the size of a battery or a hard drive received in one of the compartments 154a-d may have to be reduced, with a respective reduction in memory or battery capacity. Accordingly, it may be important to produce substantially square corners or otherwise remove material to meet component specifications.

Certain existing technologies may allow for removal of material from locations that may be difficult or impossible to remove using a mill and a rotating cutting tool in a conventional manner. For example, Electro Chemical Machining (ECM) is a process wherein material is removed by controlled dissolution. More particularly, metal particles are removed by the application of electrical power and a saline solution, which washes away the removed particles. Further, material removal may also be accomplished via Electric Discharge Machining (EDM), which is also known as spark erosion. EDM functions by inducing a spark between an electrode and the substrate that results in a very small crater on the surface thereof. By producing repetitive sparks, more material is removed, and the waste material may then be washed away. Like ECM, the material closest to the electrode is affected first.

However, ECM, EDM, and other similar methods of removing material are relatively slow. Further, ECM and EDM typically require removal of the substrate from the CNC mill to perform these operations, resulting in additional manufacturing complexities and manufacturing time. Accordingly, improved material removal processes may be desirable.

Corner mills configured to produce substantially square holes are presently available. For example, corner mills are available from Dijet Industrial Company of Osaka, Japan. However such corner mills are respectively configured to produce one size of a hole. In this regard, each corner mill may include a cam mechanism or other mechanical means that moves flutes such that they extend to varying radial distances with respect to a rotational axis when rotating thereabout. Further, such corner mills are configured only as end mills for use in plunging operations to produce such square holes.

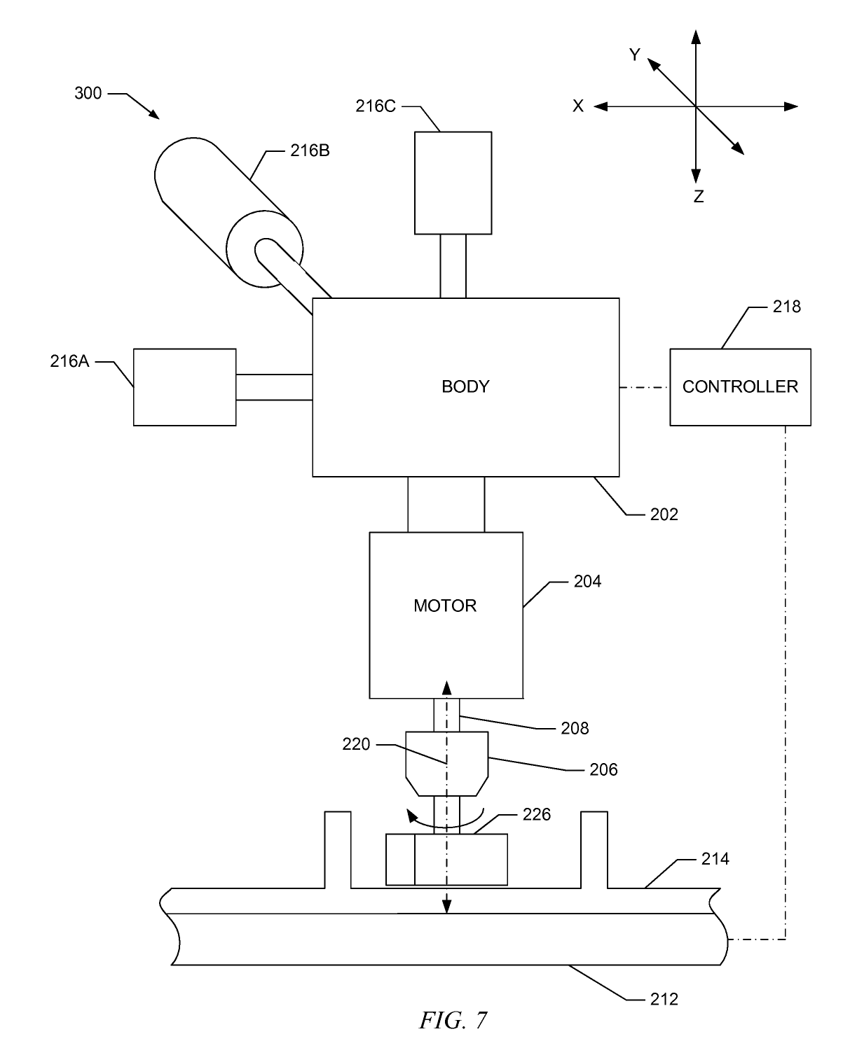

In this regard, FIG. 7 illustrates a material removal system 300 according to an example embodiment of the present disclosure. As illustrated, in one embodiment the material removal system 300 may include some of the components of the CNC mill 200 described above. In this regard, one embodiment of the present disclosure is configured for use with a standard CNC mill or other rotary machine. However, as illustrated, the material removal system 300 may include a differing embodiment of a cutting tool 226.

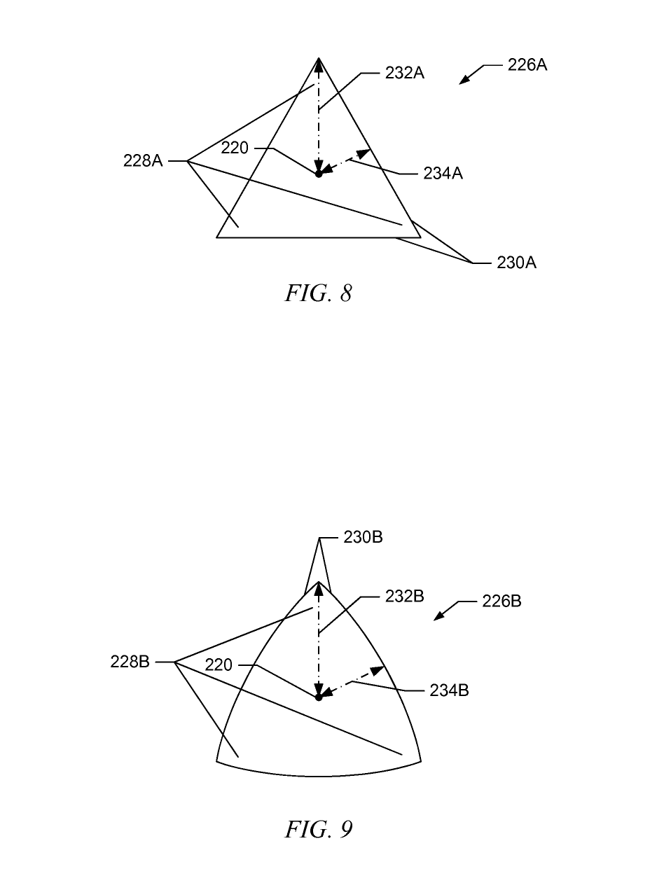

In this regard, FIGS. 8 and 9 illustrate top views of example embodiments of the cutting tool 226. More particularly, FIG. 8 illustrates a cutting tool 226A defining a triangular profile with three flutes 228A respectively defining one or more linear cutting edges 230A. FIG. 9 illustrates a cutting tool 226B defining a generally triangular profile with three flutes 228B respectively defining one or more curved cutting edges 230B. In this regard, the cutting tools 226 employed with embodiments of the present disclosure may include one or more flutes 228A, B such that a radial distance of the cutting tool differs about the perimeter thereof. For example, as illustrated in FIGS. 8 and 9, the flutes 228A, B extend to a greater radial distance 232A, B as compared to a radial distance 234A, B of areas therebetween.

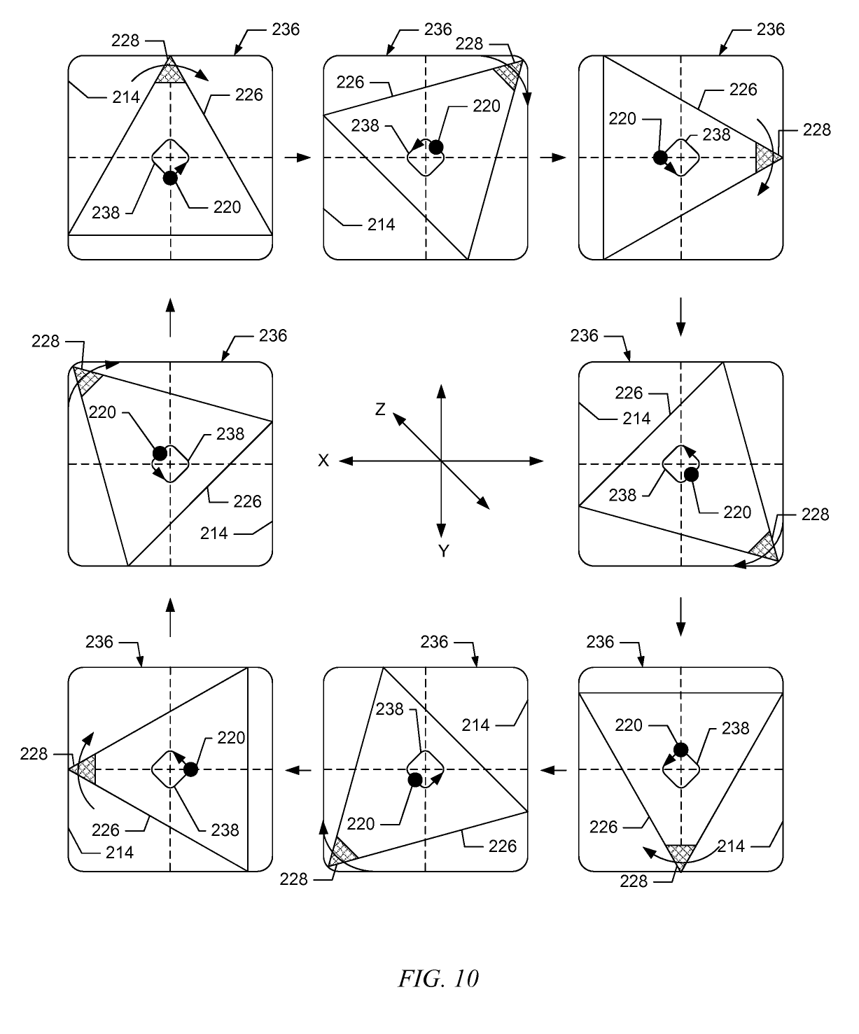

As noted above, rotation of the cutting tool 210 using the CNC mill 200 may result in the formation of undesirable remaining material sections 222 at areas where the production of a sharp corner is desired (see, e.g., FIG. 6). In this regard, embodiments of the present disclosure may be configured to machine corners and other shapes in a substrate that may not be machined using traditional rotary tools and machining methods. By way of example, FIG. 10 illustrates use of a cutting tool 226 (e.g., cutting tool 226A from FIG. 8) according to an embodiment of the present disclosure to cut a rectangular hole 236 (e.g., a square hole) in a substrate 214.

More particularly, FIG. 10 illustrates the changing position of the cutting tool 226 during clockwise rotation thereof about the axis 220. Further, FIG. 10 illustrates movement of the cutting tool 226 perpendicularly to the axis 220 during rotation of the cutting tool 226 about the axis. This translational movement (e.g., non-rotary movement) perpendicular to the axis 220 may be conducted in a plurality of directions defining a pattern synchronized with each rotation of the cutting tool 226 about the axis. In this regard, while the cutting tool 226 rotates about the axis 220, the cutting tool may be translated along a path 238. As illustrated, the cutting tool 226 may be translated such that the axis 220 of rotation thereof follows the path 238 in a generally opposite to the direction of rotation of the cutting tool. Further, the cutting tool 226 may be moved (e.g., translated) into contact with the substrate 214 during the above-described translational and rotational movements. In this regard, the cutting tool 226 may be an end mill that may be plunged along the axis 220 of rotation (during the rotational movement about the axis 220 and the perpendicular movement along the path 238) into contact with the substrate 214 to create the square hole 236.

A flange 228 is marked in FIG. 10 to facilitate illustration of the movement of the cutting tool 226. As shown in FIG. 10, the flanges 228 are located on an outer peripheral portion of the cutting tool 226. The phrase “outer peripheral portion” as used in this detailed description and in the claims refers to the outer perimeter of the cutting tool 226. As illustrated, the translational movement of the cutting tool 226 along the path 238 may be configured to correspond with the radial position of the flanges 228. Thus, as illustrated, when the radial position of one of the flanges 228 corresponds to a desired position of one of the corners, the cutting tool 226 may be translated along the path 238 in the direction of the desired corner such that the corner is cut. Thus, any remaining radius of curvature at each corner of the square hole 236 may be less than a radial distance to which the flanges 228 extend (see, e.g., radial distance 232A of the flange 228 in FIG. 8), whereas use of a cutting tool without the above-described translational movements would result in corners defining a radius of curvature substantially equal to the radius to which the cutting tool extends during rotation thereof. Conversely, the path 238 may be configured such that the flanges 228 cut straight walls in the substrate where desired by extending or retracting the cutting tool in a particular direction.

As noted above, mechanical means such as the corner mill sold by Dijet may be configured to create substantially square holes in a similar manner. However, such mechanical means may suffer from certain limitations. In this regard, the mechanical means (e.g., a cam mechanism) may not be adjustable and may be configured only to cut one size of square hole for each corner mill. Further, the mechanical means may incorporate rotating parts in contact with one another (e.g., a cam and follower mechanism) that may wear over time. Accordingly, the present disclosure is configured to avoid these issues and provide other advantages.

In this regard, in accordance with embodiments of the present disclosure, the translational movement of the cutting tool 226 perpendicular to the axis 220 of rotation may be provided by the actuators 216. In particular, movement along the X-axis may be provided by the first actuator 216A and movement along the Y-axis may be provided by the second actuator 216B. Thus, for example, the actuators 216 may cause the machine body 202, the motor 204, the spindle 208, the rotary head 206, and the cutting tool 226 to move, such that the cutting tool follows the path 238 to create the desired shape in the substrate 214, as dictated by the controller 218. In this regard, by employing the actuators 216 to move the cutting tool 226, a variety of holes defining various shapes and sizes may be cut rather than a single size and shape as is the case when employing a purely mechanical mechanism such as a corner mill. Further, issues with respect to wear to cam and follower mechanisms may be avoided, since use of such mechanisms may be avoided.

The material removal system 300 according to embodiments of the present disclosure may provide additional advantages over existing embodiments of mechanical means for forming square holes in that the system may be employed to remove material from a substrate in various other manners. In this regard, it may be desirable to form a pocket in a substrate. Such pockets may be created, for example, using the CNC mill 200 to direct the rotating cutting tool 210 (e.g., embodied as a face mill or T-cutter) into contact with a side of the substrate 214.

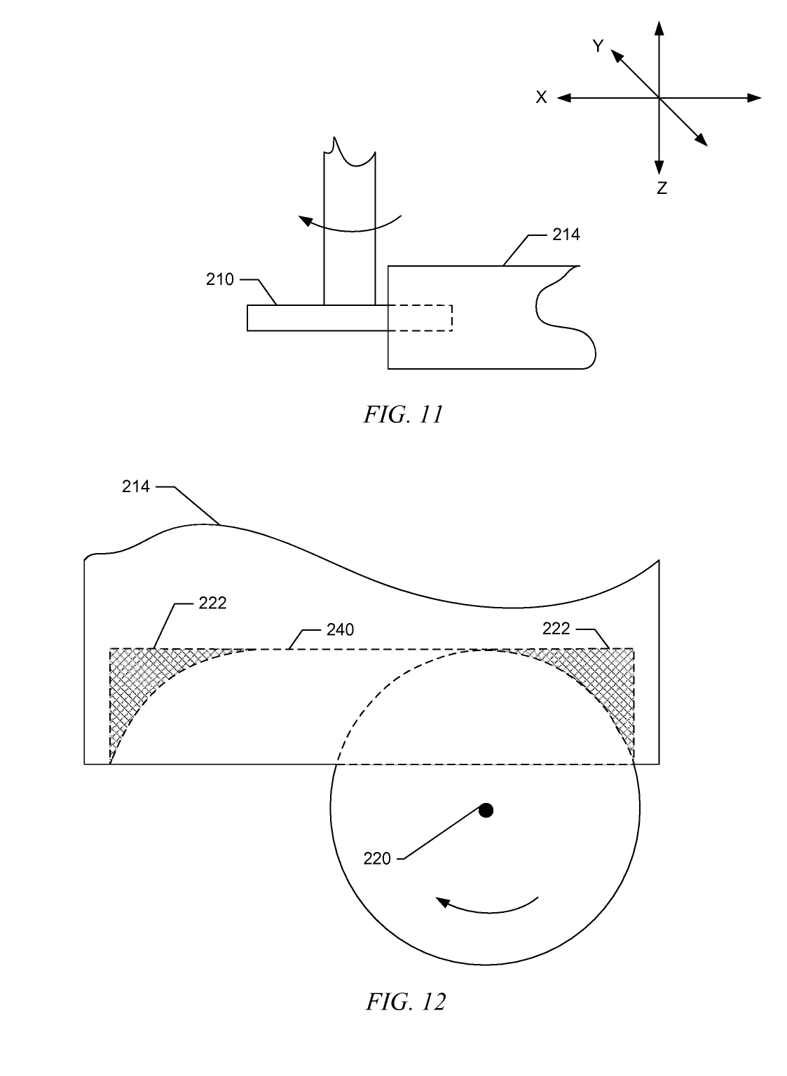

Accordingly, as illustrated in FIGS. 11-12, the cutting tool 210 may create a pocket 240. However, certain undesirable remaining material sections 222 may be created. In this regard, as discussed above, the corners of the pocket 240 may include the remaining material sections 222, which may define a radius of curvature substantially equal to a radius of the cutting tool 210. As described above, relatively more square corners may be desirable.

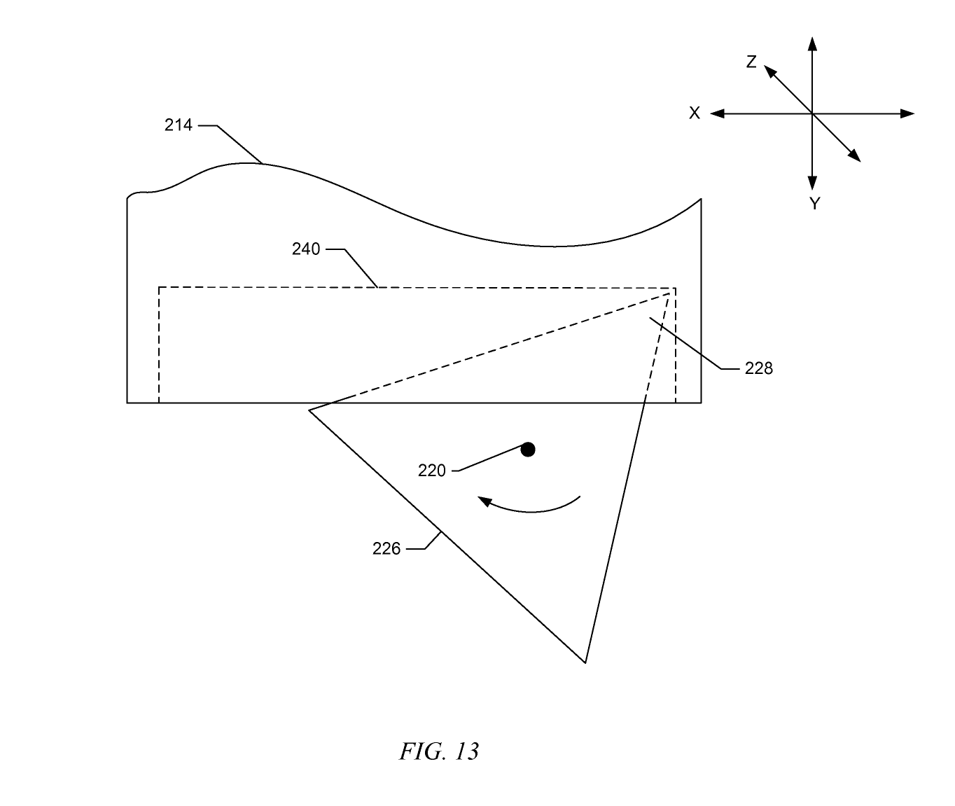

In this regard, as illustrated in FIG. 13 embodiments of the material removal system 300 may employ the cutting tool 226 (e.g., cutting tool 226A from FIG. 8, when embodied as a face mill or T-cutter), to cut the pocket 240 into the substrate 214 such that the corners thereof may be relatively more square. In this regard, the cutting tool 226 may be translated relative to the axis 220 of rotation thereof in a pattern synchronized with each of a plurality of rotations of the cutting tool. Thus, the cutting tool 226 may be translated during the rotation thereof such that the flanges 228 cut the corners and straight sections of the pocket 240 in a desired manner. In particular, the actuators 216 (e.g., the actuators 216A, B) may extend and retract the cutting tool 226 during rotation thereof such that the flanges 228 follow a desired profile to form the pocket 240.

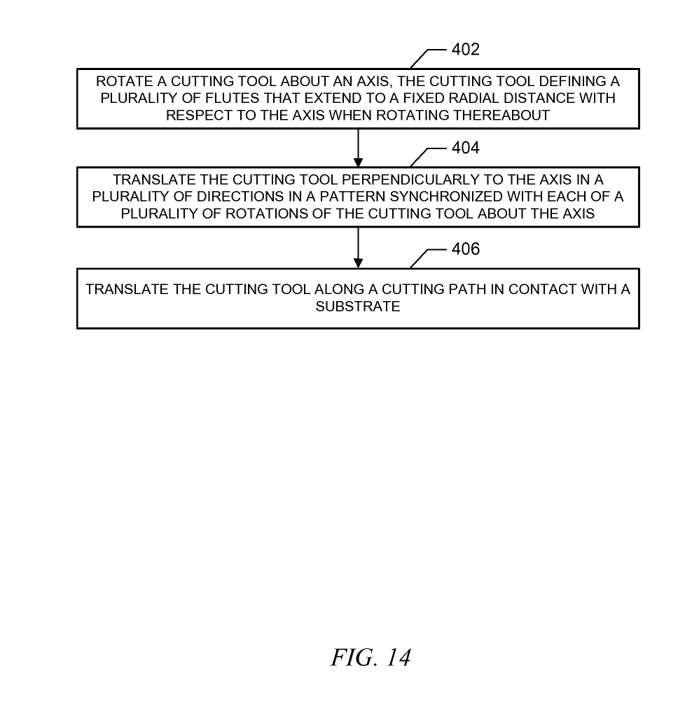

A related manufacturing method is also provided. As illustrated in FIG. 14, the method may include rotating a cutting tool about an axis, the cutting tool defining a plurality of flutes that extend to a fixed radial distance with respect to the axis when rotating thereabout at operation 402. Further, the method may include translating the cutting tool perpendicularly to the axis in a plurality of directions in a pattern synchronized with each of a plurality of rotations of the cutting tool about the axis at operation 404. Additionally, the method may include translating the cutting tool along a cutting path in contact with a substrate at operation 406.

In some embodiments of the method, rotating and translating the cutting tool at operations 402-406 may comprise cutting a corner in the substrate. Further, a radius of curvature of the corner may be less than the fixed radial distance. Additionally, translating the cutting tool along the cutting path at operation 404 may comprise plunging the cutting tool along the axis into contact with the substrate or cutting a pocket in the substrate. In some embodiments translating the cutting tool perpendicularly to the axis at operation 402 may comprise translating a rotary head of a mill.

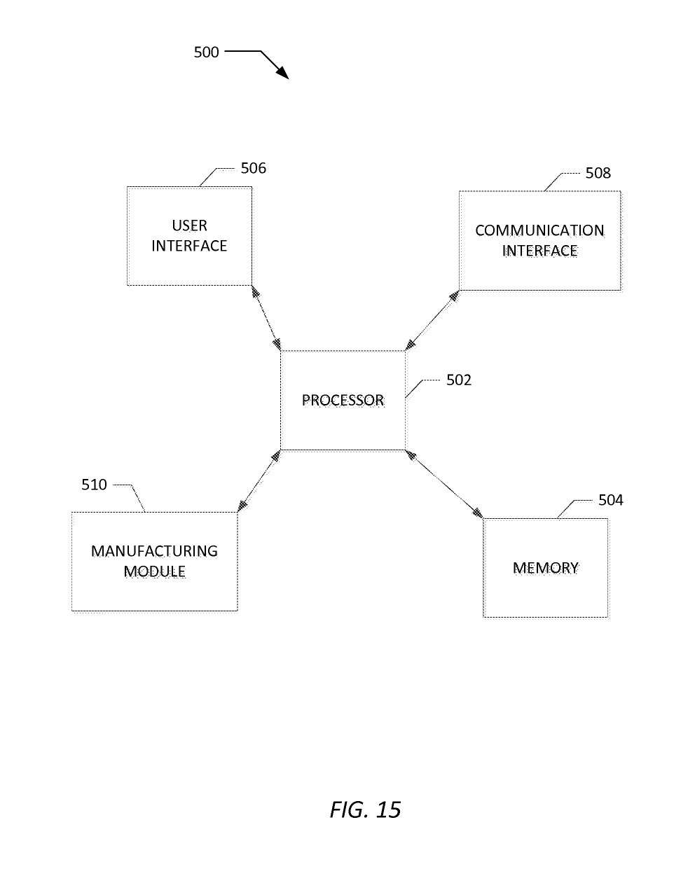

FIG. 15 is a block diagram of an electronic device 500 suitable for use with the described embodiments. In one example embodiment the electronic device 500 may be embodied in or as a controller configured for controlling manufacturing operations as disclosed herein. In this regard, the electronic device 500 may be configured to control or execute the above-described manufacturing operations performed by the CNC mill 200 of the system 300. In this regard, the electronic device 500 may be embodied in or as the controller 218.

The electronic device 500 illustrates circuitry of a representative computing device. The electronic device 500 may include a processor 502 that may be microprocessor or controller for controlling the overall operation of the electronic device 500. In one embodiment the processor 502 may be particularly configured to perform the functions described herein relating to manufacturing. The electronic device 500 may also include a memory device 504. The memory device 504 may include non-transitory and tangible memory that may be, for example, volatile and/or non-volatile memory. The memory device 504 may be configured to store information, data, files, applications, instructions or the like. For example, the memory device 504 could be configured to buffer input data for processing by the processor 502. Additionally or alternatively, the memory device 504 may be configured to store instructions for execution by the processor 502.

The electronic device 500 may also include a user interface 506 that allows a user of the electronic device 500 to interact with the electronic device. For example, the user interface 506 can take a variety of forms, such as a button, keypad, dial, touch screen, audio input interface, visual/image capture input interface, input in the form of sensor data, etc. Still further, the user interface 506 may be configured to output information to the user through a display, speaker, or other output device. A communication interface 508 may provide for transmitting and receiving data through, for example, a wired or wireless network such as a local area network (LAN), a metropolitan area network (MAN), and/or a wide area network (WAN), for example, the Internet.

The electronic device 500 may also include a manufacturing module 510. The processor 502 may be embodied as, include or otherwise control the manufacturing module 510. The manufacturing module 510 may be configured for controlling or executing the manufacturing operations as discussed herein.

In this regard, for example, in one embodiment a computer program product comprising at least one computer-readable storage medium having computer-executable program code portions stored therein is provided. The computer-executable program code portions, which may be stored in the memory device 504, may include program code instructions for performing the manufacturing operations disclosed herein.

Note that although embodiments of the present disclosure are generally directed to use of a CNC mills to machine a substrate, various other embodiments of machining apparatuses may be employed. For example, a lathe may rotate and translate a substrate with an actuator in the manners disclosed herein. Accordingly, embodiments of the present disclosure are not limited to use with a CNC mill.

Although the foregoing disclosure has been described in detail by way of illustration and example for purposes of clarity and understanding, it will be recognized that the above described disclosure may be embodied in numerous other specific variations and embodiments without departing from the spirit or essential characteristics of the disclosure. Certain changes and modifications may be practiced, and it is understood that the disclosure is not to be limited by the foregoing details, but rather is to be defined by the scope of the appended claims.

What is claimed is:

1. A method for machining a substantially square hole into a substrate, the method comprising:
rotating a cutting tool about an axis in a first direction, the cutting tool defining a plurality of flutes that extend to a fixed radial distance with respect to the axis when rotating thereabout;
translating the cutting tool along a cutting path in a second direction opposite the first direction, the cutting path arranged substantially perpendicular to the axis, wherein a translational position of the cutting tool is synchronized with each of a plurality of rotations of the cutting tool; and
wherein the plurality of flutes include a first flute defining a first cutting edge of the cutting tool.

2. The manufacturing method as recited in claim 1, wherein rotating the cutting tool and translating the cutting tool comprise cutting a corner in the substrate.

3. The manufacturing method as recited in claim 2, wherein a radius of curvature of the corner is less than the fixed radial distance.

4. The manufacturing method as recited in claim 1, wherein translating the cutting tool along the cutting path comprises plunging the cutting tool along the axis into contact with the substrate.

5. The manufacturing method as recited in claim 1, wherein translating the cutting tool along the cutting path comprises cutting a pocket in the substrate.

6. The manufacturing method as recited in claim 1, wherein translating the cutting tool perpendicularly to the axis comprises translating a rotary head of a mill.

7. The manufacturing method as recited in claim 1, wherein the cutting tool comprises a first flange.

8. The manufacturing method as recited in claim 7, wherein the cutting tool further comprises a second flange.

9. The manufacturing method as recited in claim 8, wherein the cutting tool comprises:
a first radial distance extending from a center portion of the cutting tool to the first flange; and
a second radial distance extending from the center portion of the cutting tool to a surface of the cutting tool between the first cutting and the second flange; and
wherein the first radial distance extends further the second radial distance.

10. The manufacturing method as recited in claim 1, wherein the substrate is part of a housing of a portable computing device.

11. A method of boring a rectangular hole into a substrate of a computing device with a material removal system having a spindle pivotally coupled to a substantially triangular cutting tool, the method comprising:
plunging the substantially triangular cutting tool along an axis of rotation of the substantially triangular cutting tool into contact with the substrate;
simultaneously rotating the cutting tool and translating the cutting tool in the substrate, wherein the translating the cutting tool is synchronized with the rotating the cutting tool; and
forming the rectangular hole in the substrate.

12. The method as recited in claim 11, wherein the translating the cutting tool is perpendicular to the axis of rotation.

13. The method of claim 11,
wherein the rotating the cutting tool follows a first direction;
wherein translating the cutting tool follows a second direction; and
wherein the first direction is opposite the second direction.

14. The method as recited in claim 11, wherein the translating the cutting tool is perpendicular to the axis of rotation.

15. The method as recited in claim 11, wherein the cutting tool extends a first radial distance to cut a first corner of the rectangular hole, and wherein the cutting tool extends a second radial distance to cut a second corner of the rectangular hole.

16. The method as recited in claim 15, wherein the cutting tool retracts to cut a first straight portion of the rectangular hole, and wherein the first straight portion is positioned between the first corner and the second corner.

17. The method as recited in claim 11, wherein the cutting tool includes a first flange, the first flange located in an outer peripheral portion of the cutting tool.

18. The method as recited in claim 17, wherein the distance between the center of the rectangular hole and the first corner is substantially identical to the maximum distance the first flange extends during the simultaneously rotating the cutting tool and translating the cutting tool.

19. A non-transitory computer readable medium for storing a computer-executable program in a computer system, the computer readable medium comprising:
computer code for controlling a spindle to rotate a cutting tool about an axis in a first direction, the cutting tool defining a plurality of flutes that extend to a fixed radial distance with respect to the axis when rotating thereabout; and
computer code for translating the cutting tool along a cutting path in a second direction opposite the first direction, the cutting path arranged substantially perpendicular to the axis, wherein a translational position of the cutting tool is synchronized with each of a plurality of rotations of the cutting tool.

20. The non-transitory computer readable medium as recited in claim 19, further comprising computer code for extending the cutting tool and retracting the cutting tool in a manner such that a corner is cut in a substrate, the corner having an angle approximately 90 degrees.
